(19) United States
(12) Patent Application Publication
(10) Pub. No.: US 2025/0257605 A1
(43) Pub. Date: Aug. 14, 2025

(54) BARRIER OPERATOR SYSTEM HAVING AUTOMATIC CLOSE CAPABILITY

(71) Applicant: OVERHEAD DOOR CORPORATION, Lewisville, TX (US)

(72) Inventors: Brent Rauscher, Keller, TX (US); Brent Buescher, Wooster, OH (US)

(21) Appl. No.: 18/439,436

(22) Filed: Feb. 12, 2024

(51) Int. Cl. E05F 15/77

(52) U.S. Cl. CPC E05F 15/77; E05Y 2400/66; E05Y 2400/8515

(57) ABSTRACT

A barrier operator system includes a remote server and a barrier operator configured to move a barrier. The remote server is configured to transmit a first communication to the barrier operator, receive a window acknowledgement from the barrier operator that indicates the barrier operator has initiated a window of time, and in response to receipt of the window acknowledgement transmit a barrier open request to the barrier operator. The barrier operator is configured to receive the first communication from the remote server, initiate the window of time in response to receipt of the first communication and transmit the window acknowledgement, receive the barrier open request, and in response to receipt of the barrier open request during the window of time, initiate a timer and close the barrier in response to expiration of the timer.

### FIELD

The present disclosure is directed to remotely controlled barrier operator systems for opening and closing garage doors, gates, and other moveable barriers, and more particularly to systems and methods for automatically closing a barrier when remotely opened in response to a command from a server.

### BACKGROUND

With few exceptions, barrier operators, such as those controlling upward acting sectional garage doors, rollup doors, gates, and other motor operated barriers, may be locally controlled. Barrier operators may be locally controlled by one or more wired or wireless mounted or hand-held transmitters. A user may both open and close the barrier using such transmitters.

However, some barrier operators may also be remotely controlled by remote user devices like smartphones or delivery driver control devices in which case commands to open or close a barrier may be routed through one or more networks. Because a user may open a barrier from virtually anywhere, a user may neglect to close the barrier or a communication outage in a network may prevent the user from closing the barrier after opening. Thus, it is advantageous for the barrier operator system to automatically close after a period of time has elapsed.

### SUMMARY

Consistent with an aspect of the present disclosure, a barrier operator for manipulating a barrier may include a motor operable to move the barrier between a closed position and an open position, a barrier control module configured to communicate with a remote server, and one or more processors. The one or more processors may be configured to receive a first communication from the remote server, initiate a window of time in response to receipt of the first communication, receive a barrier open request, and, in response to receipt of the barrier open request during the window of time, initiate a timer and close the barrier upon expiration of the timer.

In some examples, the barrier open request may be received from the remote server and the one or more processors may be further configured to reject the barrier open request in response to receipt of the barrier open request after the window of time has elapsed.

In some examples, the first communication may include a timer value and the one or more processors may be configured to initiate the timer using the timer value.

In some examples, the barrier open request may be received from a local transmitter. The local transmitter may be a wireless transmitter. The local transmitter may be a wired transmitter. The wired transmitter may be a wall console.

In some examples, the barrier control module may be a retrofit device configured to wirelessly transmit the barrier open request to a barrier controller of the barrier operator. The barrier controller may be configured to control operation of the motor.

In some examples, the one or more processors may be further configured to transmit a window acknowledgement to the remote server in response to determining the barrier operator is able to initiate the window of time.

In some examples, the one or more processors may be further configured to transmit an open request acknowledgement to the remote server in response to receipt of the barrier open request.

In some examples, the one or more processors may be further configured to transmit an open request acknowledgement to the remote server in response to determining the barrier operator is able to execute the barrier open request.

In some examples, the one or more processors may be further configured to transmit a close acknowledgement to the remote server in conjunction with the closing of the barrier.

In an aspect of the present disclosure, a server may be configured to communicate with a barrier operator. The server may be configured to transmit a first communication to the barrier operator, receive a window acknowledgement from the barrier operator indicating the barrier operator has initiated a window of time, and transmit a barrier open request to the barrier operator in response to receipt of the window acknowledgement.

In some examples, the server may be configured to transmit the first communication to the barrier operator in response to receipt of the barrier open request from a partner platform. The server may be further configured to initiate a timer in response to transmitting the first communication and to reject the barrier open request received from the partner platform in response to expiration of the timer. The server may be further configured to terminate the timer in response to receipt of a window acknowledgement from the barrier operator indicating the barrier operator is able to initiate the window of time.

In some examples, the server may be further configured to receive a close acknowledgement from the barrier operator indicating the barrier operator has closed a barrier and transmit a close confirmation to the partner platform.

In an aspect of the present disclosure, a barrier operator system may include a remote server and a barrier operator configured to move a barrier. The remote server may be configured to transmit a first communication to the barrier operator, receive a window acknowledgement from the barrier operator indicating the barrier operator has initiated a window of time, and transmit a barrier open request to the barrier operator in response to receipt of the window acknowledgement. The barrier operator may be configured to receive the first communication from the remote server, initiate the window of time in response to receipt of the first communication, transmit the window acknowledgement, receive the barrier open request, and in response to receipt of the barrier open request during the window of time, initiate a timer and close the barrier upon expiration of the timer.

In some examples, the barrier operator may be further configured to reject the barrier open request in response to receipt of the barrier open request after the window of time has elapsed.

In some examples, the first communication may include a timer value and the barrier operator may be configured to initiate the timer using the timer value.

In some examples, the barrier open request may be received at the barrier operator from a local transmitter.

In some examples, the barrier operator may include a retrofit device configured to wirelessly transmit the barrier open request to a barrier controller of the barrier operator. The barrier controller may be configured to control operation of a motor.

Other examples include corresponding methods, computer systems, apparatuses, devices, and instructions recorded on one or more computer-readable storage mediums, each related to the functions described herein.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

The accompanying drawings illustrate implementations of the systems, devices, and methods disclosed herein and together with the description serve to explain the principles of the present disclosure.

FIG. 1 is a perspective view of a barrier operator system in accordance with an example of the present disclosure.

FIG. 2 is a block diagram of a barrier operator system in accordance with an example of the present disclosure.

FIG. 3 is a flow chart illustrating an example of communication routing in a barrier operator system in accordance with the present disclosure.

FIG. 4 is a flow chart illustrating an example method of operation of a barrier operator system in accordance with an example of the present disclosure.

Examples of the present disclosure and their advantages are best understood by referring to the detailed description that follows. It should be appreciated that like reference numerals are used to identify like elements illustrated in one or more of the figures, wherein showings therein are for purposes of illustrating examples of the present disclosure and not for purposes of limiting the same.

### DETAILED DESCRIPTION

The devices and techniques disclosed in this document may be used to provide automatic closure functionality in a barrier operator system.

In the following description, like elements are marked throughout the specification and drawings with similar reference numerals. The drawing figures are not necessarily drawn to scale and certain elements are shown in generalized or schematic form in the interest of clarity and conciseness. It should be understood that the embodiments of the disclosure herein described are merely illustrative of the principles of the invention.

In modern barrier operator systems, while users may locally control a barrier operator with traditional transmitters such as a wired or wireless button on wall console or a hand-held radio frequency (“RF”) remote control, users are also able to remotely control a barrier operator to initiate barrier movements and receive barrier status information through a remote user device, such as a smartphone or computer. In some instances, a user of a remote user device may be an owner or tenant of the premises at which the barrier operator is installed. In some instances, a user of a remote user device may be a delivery driver tasked with making a delivery to the premises.

The remote user device may use a wireless and/or wired network connection to communicate with one or more remote servers operated by a barrier operator company (“operator cloud processing platform”) that manufactures, sells, and/or manages a plurality of barrier operators. The operator cloud processing platform, in turn, is in wired and/or wireless communication with the barrier operator through one or more networks. In many instances, a barrier operator may communicate in a local wireless network of a user via a router. In this way, a user may be able to use the remote user device to request that the barrier operator move the barrier. It should be appreciated that the term “request” as used herein may be used interchangeably with command, instruct, or like terms. It should be appreciated that sending a barrier movement request such as a barrier open request or a barrier close request may not necessarily result in the requested movement occurring, as a cloud processing platform and/or the barrier operator may institute one or more system status assessments as a condition of executing the request, as discussed further below.

When initiating a barrier open request through a user interface of a remote user device, a user could theoretically be located anywhere in the world with an internet connection and may not have visual contact with the barrier to observe a position of the barrier. Thus, the user may request the barrier operator to open the barrier via the remote user device and subsequently either forget to close the barrier or a network connection between the remote user device and the barrier operator (e.g., cellular network, satellite network, wide area network, local network, cloud processing platform, etc.) may experience an outage, preventing the user from closing the barrier from the remote user device. This may be undesirable if the user relies on the barrier being closed to secure the premises. As a result, automatic closure of the barrier at some point in time following the opening of the barrier may be desired. While automatic closure of the barrier could theoretically be implemented by the remote user device or a cloud processing platform, the above concerns regarding network communication outages may preferably be addressed by implementing automatic closure functionality locally at the barrier operator. That is, a timer tracking an elapsed time since the barrier opened may be preferably maintained at the barrier operator to ensure closure of the barrier.

Accordingly, the present disclosure contemplates systems and methods for performing automatic closure at a barrier operator. Systems and methods of the present disclosure may utilize separate and discrete requests for: 1) initiating a window of time at the barrier operator; and 2) automatically closing the barrier after expiration of a timer if an open request is received at the barrier operator during the window of time. Communications from the server to the barrier operator to initiate the window of time and to open the barrier may be separated both temporally and functionally.

As an example of operation of a barrier operator system of the present disclosure, a user may access a user interface on a remote user device and provide an indication that the user desires the barrier to be opened by providing an input via the remote user device. For example, the user may press a button presented on a graphical user interface, press a physical button on the remote user device, provide a voice command, etc. The remote user device may then transmit a message to a cloud processing platform associated with the remote user device indicating that the user has requested opening of the barrier. In response to receipt of the message from the remote user device, the cloud processing platform (or a second cloud processing platform in communication with the cloud processing platform) may generate and transmit a communication to the barrier operator to prompt the barrier operator to initiate a window of time. Optionally, the cloud processing platform may also generate, but retain, a barrier open request. That is, the cloud processing platform may buffer a barrier movement request for later transmission.

Upon receipt of the communication, the barrier operator may perform one or more system status assessments related to barrier movement. For example, the barrier operator may assess, via signals received from a sensor, whether an obstruction is currently preventing movement of the barrier. As another example, the barrier operator may assess whether it has detected an error state (e.g., power supply issue, motor temperature anomaly, alert module not functioning properly). A result of the one or more system status assessments may be transmitted to the cloud processing platform. If there are no detected issues preventing movement of the barrier and/or initiation of the window of time, the barrier operator may initiate the window of time and transmit a window acknowledgement to the cloud processing platform.

If the window acknowledgement signal is not received by the cloud processing platform, or if it is received after a defined period of time has elapsed from when the communication was sent, the cloud processing platform will abort the barrier opening and refrain from sending a barrier open request. In response to receiving the window acknowledgement signal from the barrier operator, the cloud processing platform may then send the barrier open request to the barrier operator which the barrier operator will execute if it is presently able to do so (e.g., no detected issues preventing the movement).

Upon receiving any open command during the window of time from the cloud processing platform or any other source (e.g., local), the barrier operator will start a timer.

Examples of barrier operator systems, including cloud processing platforms, barrier operators, and remote user devices, in accordance with the present disclosure are discussed below in relation to the figures.

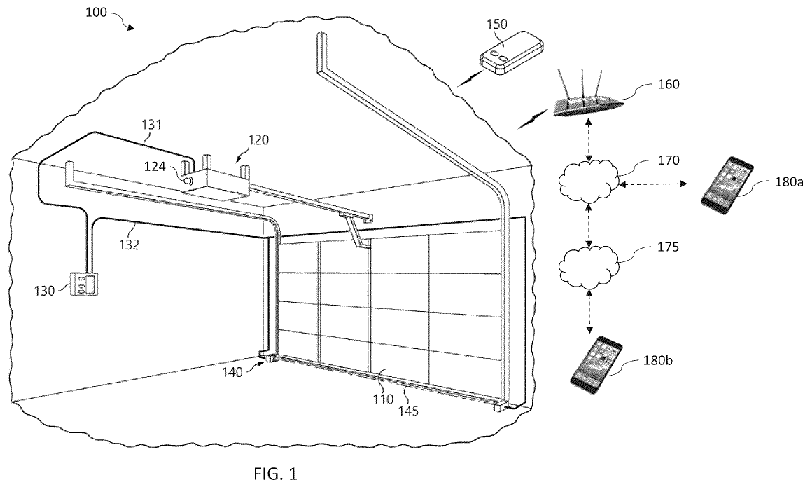

FIG. 1 illustrates example components of a barrier operator system 100. In the illustrated example, the barrier 110 is an upward-acting sectional garage door movable between a closed position shown and an open position. Barrier 110 is movable between its open and closed positions by a barrier operator 120, shown as a ceiling-mounted motor driven garage door operator. It should be appreciated that the present disclosure is not limited to upward-acting sectional garage doors and ceiling-mounted garage door operators. In some examples, the barrier 110 may be a sliding or rolling gate and the barrier operator 120 may be gate opener. In other examples, the barrier operator 120 may be a wall-mounted jackshaft type door operator. For an example of components that may be included in the barrier operator 120, see U.S. Pat. App. Pub. No. 2020/0340288, which is incorporated by reference herein in its entirety.

Barrier operator 120 is operably connected to a wall console 130 mounted on a wall. Barrier operator 120 and wall console 130 are in operative communication via wired conductor 131, although wireless transmission between the wall console 130 and barrier operator 120 is also suitable. One or more buttons on the wall console 130 may be configured to transmit a door movement command to the barrier operator 120. A hand-held (or vehicle-mounted) transmitter 150 may transmit door movement commands to the barrier operator 120 via a suitable RF channel.

Barrier operator 120 may configured to connect to a wireless network, such as Wi-Fi, provided by a router 160 at the user premises and thus may receive and/or transmit signals to/from the router 160 over the wireless network. The router 160 may be connected to a first cloud processing platform 170 via a wired and/or wireless network which may include the internet. The cloud processing platform 170 may comprise one or more servers, such as cloud servers. In some examples, the one or more servers may be at least partially dedicated barrier operator servers maintained by a barrier operator service provider, such as a barrier operator manufacturer. The first cloud processing platform 170 may receive monitoring data from a plurality of barrier operators and may send barrier movement requests to each of the plurality of barrier operators. The first cloud processing platform 170 may host an interface allowing barrier operator owners and users remote access to monitor and control barrier operators associated with a respective user account through a mobile application on a remote user device 180a such as a smartphone. As such, the first cloud processing platform 170 may be termed an “operator cloud processing platform.”

The first cloud processing platform 170 may be connected to a second cloud processing platform 175 via a wired and/or wireless network that may include the internet. The second cloud processing platform 175 may comprise one or more servers, such as cloud servers. In some examples, the one or more servers may be at least partially dedicated delivery logistics servers maintained by a retail company and/or a delivery company such as a grocery store, an online marketplace, USPS, UPS, Amazon, FedEx, DoorDash, etc. These companies may partner or otherwise engage in coordination with a barrier operator service provider to facilitate access through barriers to make deliveries. As such, the second cloud processing platform 175 may be termed a “partner cloud processing platform.” The second cloud processing platform 175 may manage customer orders and delivery information associated with respective customer accounts. In some examples, the first cloud processing platform 170 and the second cloud processing platform 175 may be combined into a single platform.

A remote user device 180b may be in operative communication with the second cloud processing platform 175 via a wired and/or wireless network connection, such as via a mobile phone network. The remote user device 180b may be a smartphone, tablet computer, or the like or a mobile delivery computer as are known in the industry (e.g., those marketed by Zebra Technologies). The remote user device 180b may be used to control movement of the barrier operator 120 via the second cloud processing platform 175, the first cloud processing platform 170, and the router 160, along with any associated communication networks.

The barrier operator system 100 also includes an alert module 124. The alert module 124 may include one or more lights and/or sound emitters. The alert module 124 may be internal to the barrier operator 120 such that the alert module is disposed within the housing of the barrier operator 120 or the alert module 124 may be a distinct apparatus. That is, the alert module 124 may be external to the barrier operator 120 and may be in wired or wireless communication with the barrier operator 120. For example, the alert module 124 may communicate with the barrier operator 120 via a Wi-Fi or Bluetooth connection. The alert module may be used to perform imminent motion notifications to alert people in the vicinity of the barrier 110 that the barrier 110 will soon begin moving.

The barrier operator system 100 also includes a sensor device 140. In the illustrated example, the sensor 140 is positioned adjacent to the barrier 110 and includes an optical or infrared beam transmitter disposed on one side of the aforementioned doorway and a receiver disposed on the opposite side. Such a device is commonly referred to as a “safety beam” or “photo eye.” The sensor 140 is operable to send a signal to the barrier operator 120, either directly or by way of the console 130 as illustrated, via a wired conductor 132 or wireless transmission. Such a signal may indicate to the barrier operator 120 when an obstruction breaks the beam 145 between the transmitter and receiver of the sensor 140.

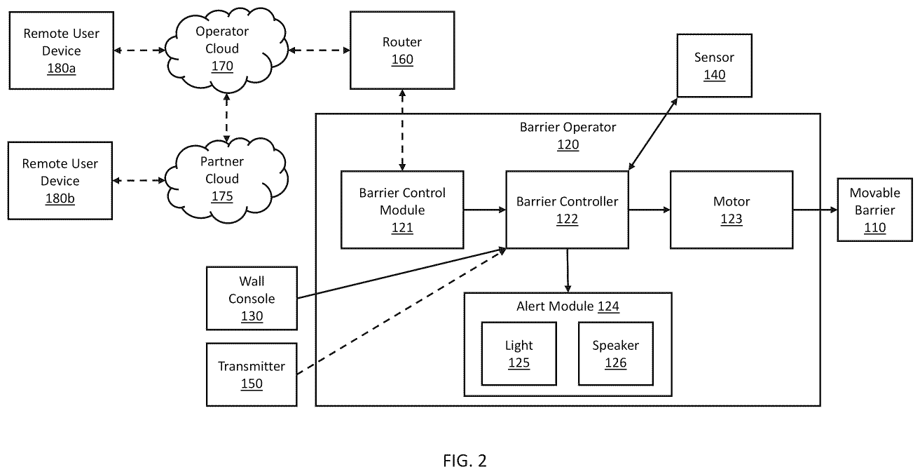

FIG. 2 illustrates a schematic diagram of components of the barrier operator system 100. The barrier operator 120 may include a barrier control module 121 and a barrier controller 122. The barrier control module 121 and the barrier controller 122 may be discrete modules, embodied in software, hardware, or both, configured to perform particular functions of the barrier operator 120 described herein. In some examples, the barrier control module 121 and barrier controller 122 may be integrated into a single module.

In the illustrated example, the barrier control module 121 handles network communication. The barrier control module 121 may include a Wi-Fi transceiver and one or more processors. For example, a first processor of the barrier control module 121 may control the Wi-Fi transceiver and a second processor of the barrier control module 121 may interface with the barrier controller 122 to send and receive communications therebetween. As illustrated, the barrier control module 121 and the barrier controller 122 are both disposed within a common housing of the barrier operator 120. In some examples, the barrier control module 121 may be external to the housing of the barrier operator 120 and may communicate with the barrier controller 122, by wired or wireless communication. For example, the barrier control module 121 may be housed within the wall console 130 or located elsewhere in the system 100. In some examples, the barrier operator 120 may be an existing barrier operator and the barrier control module 121 may be disposed in a retrofit device such as a control module configured to be mounted to the wall, the ceiling, or otherwise remote from but within wireless communication range of the barrier operator 120.

The barrier controller 122 is tasked with operation of the motor 123, alert module 124, and various other components of the barrier operator 120 (some of which are not shown to avoid obfuscating the present disclosure). As limited examples, the barrier controller 122 may interface with the wall console 130, the sensor device 140, an RF receiver configured to receive communications from the transmitter 150, and/or a motor shaft encoder or other position sensor device. The barrier controller 122 may monitor a status of the barrier 110 and transmit status information to the barrier control module 121 for network transmission to the first cloud processing platform 170 and, in turn, a remote user device 180a. The barrier controller 122 may also perform system status assessments to evaluate whether a commanded movement of the barrier 110 is performable (e.g., there are no detected issues preventing the movement from being executed). In some examples, the barrier controller 122 may detect an anomaly in one or more drive components (e.g., excessive motor torque indicating a track may be bent or a roller stuck) or the alert module 124 (e.g., light bulb inoperative) indicating that the movement cannot be executed, or it may detect an obstruction via the sensor device 140.

Although the alert module 124 in FIG. 2 is shown as being internal to the barrier operator 120, it should be understood that an alert module 124 may be located externally to the barrier operator 120, as described above. The alert module 124 may include one or more lights 125 and/or sound emitters 126. The alert module 124 may be a distinct apparatus dedicated to performing imminent motion notifications (“IMN”). As conventional barrier operators often include a light 125 and/or a speaker 126 for illuminating an area around the barrier operator and visually conveying status information to a user, the alert module 124 may include the conventional light 125 and/or speaker 126 of the barrier operator. In this regard, the barrier controller 122 may be configured to operate such a light 125 and/or speaker 126 both for conventional purposes and for imminent motion notifications. In some implementations, the barrier control module 121 may be in direct communication with the alert module 124 rather than indirectly through the barrier controller 122. Although illustrated as an integral component of the barrier operator 120, it should be appreciated that in some examples the alert module 124 may be disposed external to the housing of the barrier operator 120. For example, a remote alert module may be mounted near a walk-through door in a user's garage and may be in wired or wireless communication with the barrier control module 121 or barrier controller 122. The alert module 124 may be configured to perform an IMN to notify people in the vicinity of the barrier 110 that movement of the barrier 110 is imminent. The IMN may include, for example, flashing one or more lights, emitting an audible noise, a combination of both, or any other suitable means to convey that movement of the barrier will soon occur.

An IMN may be performed for any barrier movements initiated in response to a barrier movement request received from the cloud processing platform 170. In some examples, the barrier control module 121 may be configured to instruct the alert module 124 to perform an IMN prior to any barrier movement resulting from a barrier movement request from the cloud processing platform 170. In some examples, a barrier movement request from the cloud processing platform 170 may include an instruction or indication that causes the barrier control module 121 to instruct the alert module 124 to perform an IMN. For additional discussion of IMN operation, see U.S. patent application Ser. No. 18/529,601, which is incorporated by reference herein in its entirety.

As indicated above, the barrier control module 121 may configured to connect to a wireless network, such as Wi-Fi, provided by router 160 and thus may receive and/or transmit signals to/from the router 160 over the wireless network. In some embodiments, the barrier control module 121 may perform one or more system status assessments or may command the barrier controller 122 to perform one or more system status assessments.

The router 160 may be connected to the cloud processing platform 170 via a wired or wireless network which may include the internet. The cloud processing platform 170 may comprise one or more servers, such as cloud servers. In some examples, the one or more servers may be dedicated barrier operator servers maintained by a barrier operator service provider, such as a barrier operator manufacturer. The remote user device 180a may be in operative communication with the cloud processing platform 170 via a wired or wireless internet connection, such as via a mobile network. Thus, the remote user device 180a is in operative communication with the barrier operator 120, for example via the cloud processing platform 170 and the router 160, to receive barrier operator status information and to send barrier movement requests.

In some examples, all barrier movement requests to be executed, whether originating locally from the wall console 130 or transmitter 150 or remotely from the cloud processing platform 170, are ultimately received at the barrier controller 122 which then activates the motor to move the barrier. Conversely, only remotely generated barrier movement requests from the cloud processing platform 170 may be received by the barrier control module 121. The cloud processing platform 175 may be connected to the cloud processing platform 170 via a wired or wireless network which may include the internet. The cloud processing platform 175 may comprise one or more servers, such as cloud servers. In some examples, the one or more servers may be dedicated delivery logistics servers maintained by partner company. The remote user device 180b may be in operative communication with the cloud processing platform 175 via a wired or wireless internet connection, such as via a mobile network. Thus, the remote user device 180b is in operative communication with the barrier operator 120, for example via the cloud processing platforms 170, 175 and the router 160 to send barrier movement requests and/or receive barrier operator status information.

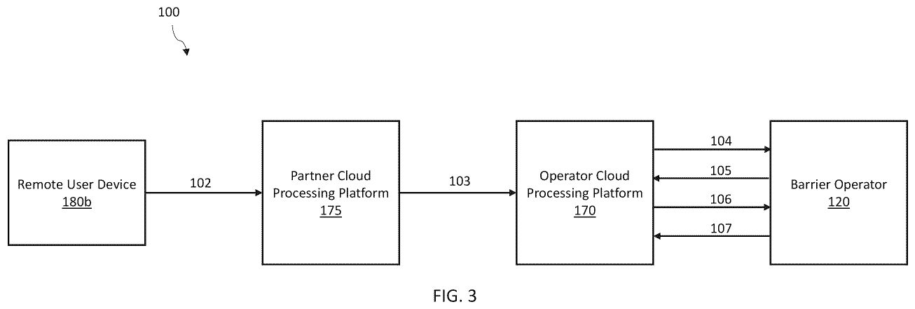

FIG. 3 graphically illustrates an example of communication in barrier operator system 100 in relation to executing a remotely generated barrier movement command from the remote user device 180b. The remote user device 180b may present a user interface to a user, such as a delivery driver, via a display. The user interface may be generated by an application executed on the remote user device 180b or may be generated by the cloud processing platform 175 and presented on the display via a portal. The user may provide an input via the user interface indicating a request 102 to open a barrier. The partner cloud processing platform 175 may validate the barrier open request 102. For example, the partner cloud processing platform 175 may verify access permissions of the user, the user device 180b, or both.

In some examples, the remote user device 180b may incorporate GPS or other location tracking functionality. The remote user device 180b may also store or access a list of scheduled deliveries and locations associated with each delivery. Upon approaching a premises associated with a scheduled delivery, the remote user device 180b may present an open button or other input on the display allowing the delivery driver to initiate a barrier open request 102 associated with the delivery (e.g., by tracking number) and/or the premises (e.g., by address or coordinates).

The partner cloud processing platform 175, upon receiving the barrier open request 102, may access a database to link the request 102 to information pertaining to a particular customer. For example, the request 102 may include a tracking number associated with the delivery and the partner cloud processing platform may maintain a database of pending tracking numbers and associated user account numbers, user account names, delivery addresses, and/or other suitable delivery information that links a particular delivery to a particular premises. In some examples, the barrier operator company may provide barrier operator information to the partner and the partner cloud processing platform may maintain a database that associates partner customers with one or more barrier operators by a device identification number (e.g., serial number or other unique identifier of the barrier operator). The barrier operator company may obtain information sharing permissions for the sharing of such information from each user and/or user account maintained by the barrier operator company, for example, through an application on the remote user device 180a or a web portal, for customers choosing to opt-in to barrier operation for partner deliveries.

In response to receiving the barrier open request 102, the cloud processing platform 175 forwards that barrier open request or generates a second barrier open request 103. The barrier open request 103 may be substantially identical to the barrier open request 102 (e.g., include similar delivery information) or may contain different delivery information. In some examples, the partner company may provide delivery customer information to the barrier operator company and the operator cloud processing platform 170 may maintain a database that associates partner customers with one or more barrier operators. The barrier operator company may obtain information sharing permissions for the sharing of such information from each user and/or user account maintained by the barrier operator company, for example, through an application on the remote user device 180a or a web portal, for customers choosing to opt-in to barrier operation for partner deliveries. In some examples, the barrier open request 102 may include a tracking number and the barrier open request 103 may include an address that the partner cloud processing platform 175 has associated with the tracking number. In some examples, the barrier open request 102 may include a tracking number and the barrier open request 103 may include a customer name that the partner cloud processing platform 175 has associated with the tracking number. In some examples, the barrier open request 102 may include geographic location data and the barrier open request 103 may include an address or customer name that the partner cloud processing platform 175 determines is in the vicinity of the geographic location. In some examples, the barrier open request 103 may include a device identification number identifying a particular barrier operator free from any physical location or personal identifiable information.

The barrier open request 103 may also include a timer value indicating a length of time that the barrier is requested to remain open before initiating an automatic closure. In some examples, the barrier open request 102 may provide the timer value, for example, based on an input provided by the delivery driver via the remote user device 180b. In some examples, the partner cloud processing platform 175 may append the timer value to the barrier open request 103. The timer value may be a fixed value set by the partner company or may be customized for a particular delivery. For example, the partner cloud processing platform may provide a timer value in the barrier open request 103 that is based on delivery factors such as the type of delivery (e.g., packages or groceries) or the quantity of items being delivered (e.g., number of parcels). In this regard, small deliveries that can be made quickly may be associated with a relatively short timer value (e.g., 30 seconds) while deliveries of a large quantity of groceries or a large parcel requiring handling equipment (e.g., a dolly) may be associated with a relatively long timer value (e.g., 5 minutes).

Upon receipt of the barrier open request 103, the operator cloud processing platform 170 may perform one or more validations of the barrier open request 103. For example, the operator cloud processing platform may determine the user associated with the request is not opted-in to partner deliveries or that the barrier operator associated with the barrier open request 103 is already open. In such an instance, the operator cloud processing platform 170 may reject the request, log the request, and/or send a communication to the partner cloud processing platform 175 indicating the requested action will not be performed. If the barrier open request 103 is validated by the operator cloud processing platform 170, the operator cloud processing platform 170 may send a first communication 104 to the barrier operator 120. The barrier operator 120 may be identified and the first communication 104 addressed to the barrier operator 120 (as opposed to other barrier operators managed by the operator cloud processing platform 170) based on a device identification number contained in the barrier open request 103 or as determined by the operator cloud processing platform based on other information in the barrier open request 103 (e.g., address, user account, etc.).

The first communication 104 may be configured to initiate a window of time at the barrier operator 120. The duration of the window of time may be fixed (e.g., 2 minutes) or may be identified by the barrier operator 120 based on window information contained within the first communication 104. The first communication 104 may contain the timer value provided by the barrier open request 103. Receipt of the timer value in the first communication 104 may prompt the barrier operator 120 to initiate a countdown timer for the window of time. It should be appreciated that the duration of the window of time may be unrelated to the timer value provided in the barrier open request 103 but rather may operator based on a different timer value distinct therefrom.

The operator cloud processing platform 170 may be configured to initiate an open timer maintained on the operator cloud processing platform 170 in response to sending of the first communication 104. The open timer may operate using a fixed or variable duration during which the operator cloud processing platform 170 will await an acknowledgement communication 105 from the barrier operator 120 indicating the barrier operator 120 received the first communication and/or the barrier operator 120 has initiated or will initiate the window of time. If the open timer at the operator cloud processing platform 170 expires without receipt of the acknowledgement communication 105, the operator cloud processing platform 170 may determine the barrier operator 120 is unable to execute opening of the barrier and may transmit a communication to the partner cloud processing platform 175 indicating that barrier cannot be opened.

Upon receipt of the first communication 104, the barrier operator 120 may perform one or more validations associated with the first communication 104. For example, the barrier operator 120 may determine a current position of the barrier, a current status of one or more sensors, etc. If the barrier operator 120 determines a barrier movement cannot be performed, the barrier operator 120 may notify the operator cloud processing platform 170 that the barrier movement cannot be performed. The operator cloud processing platform 170 may then reject the barrier open request 103. If, however, the barrier operator 120 determines a barrier movement can be attempted, the barrier operator will transmit the acknowledgement communication 105 to the operator cloud processing platform 170. In conjunction with sending of the acknowledgement communication 105, the barrier operator 120 will initiate the window of time. The window of time indicates a period during which the barrier operator 120 will attempt to perform a barrier open request from the operator cloud processing platform 170, should one be received, with an associated timer-to-close function (automatic closure). The window of time may be maintained by the barrier operator 120 by starting a timer with a value associated with the window of time and decrementing the timer based on a clock signal, starting the timer at zero and incrementing the timer based on a clock signal, or by subsequently comparing a timestamp of an open request received from the operator cloud processing platform 170 with a timestamp of the first communication 104, a timestamp of the acknowledgement communication 105, or a timestamp of when the window was initiated. An open command received outside the window of time will be rejected by the barrier operator 120.

Upon receipt of the acknowledgement communication 105 from the barrier operator 120, the operator cloud processing platform 170 may transmit a barrier open request 106 to the barrier operator 120. The operator cloud processing platform 170 may generate the barrier open request 106 in response to receipt of the acknowledgement communication 105 or may generate the barrier open request 106 in response to receipt of the barrier open request 103 but may retain the barrier open request 106 in a buffer until the acknowledgement communication 105 is received and then release it. The latter instance may be preferable in reducing latency between generation of the barrier open request 102 at the remote user device 180b and subsequent movement of the barrier.

Upon receipt of the barrier open request 106, the barrier operator 120 may perform one or more validations associated with the barrier open request 106. For example, the barrier operator 120 may determine a current position of the barrier, a current status of one or more sensors, etc. The barrier operator 120 may also determine if the barrier open request 106 is received within the window of time initiated in response to the first communication 104. If the barrier operator 120 determines the requested barrier movement cannot be performed, for example if the barrier open request 106 is received after the window of time has expired, the barrier operator 120 may notify the operator cloud processing platform 170 that the barrier open request 106 has been rejected. If, however, the barrier operator 120 is able to attempt the requested barrier opening movement, the barrier operator will initiate movement of the barrier and, in conjunction therewith, transmit an open command acknowledgement 107 to the operator cloud processing platform 170 indicating the opening movement has been performed or will be performed. Additionally, in conjunction with opening the barrier, in some examples the barrier operator 120 initiates the timer-to-close function which may use the timer value provided in the first communication 104.

Any barrier open request received during the window of time initiated by receipt of the first communication 104 will result in the barrier operator 120 initiating the timer-to-close function. That is, once the window of time has been initiated, a barrier open request received from the operator cloud processing platform 170, a transmitter 150, or wall console 130, during the window of time will cause the barrier operator 120 to initiate the timer-to-close function using the timer value provided in the first communication 104 if the barrier is able to be successfully opened. In contrast, any open command received from the transmitter 150 or wall console 130 after the window of time has elapsed will cause the barrier operator 120 to open the barrier but not initiate the timer-to-close function. An open command received from the operator cloud processing platform 170 after the window of time has expired may result in the barrier operator 120 rejecting the request.

If a barrier open request 106 is sent by the operator cloud processing platform 170 shortly before expiration of the window of time, it will be appreciated that latency in network communications may result in the barrier open request 106 being received after the window of time has expired. Accordingly, in some examples, the barrier operator 120 may be configured to transmit an expiration message to the operator cloud processing platform 170 just before expiration of the window of time. If the barrier operator 120 receives barrier open request 106 after transmission of the expiration message but before the window of time expires, the barrier operator 120 will process the barrier open request 106 normally (e.g., validate, open barrier, initiate timer-to-close, send open acknowledgement). However, if the operator cloud processing platform 170 receives the expiration message prior to sending the barrier open request 106, the operator cloud processing platform 170 will hold the barrier open request and resent the first communication 104 to cause the barrier operator 120 to re-initiate the window of time. This communication protocol aids in addressing mis-communications that may occur between the operator cloud processing platform 170 and the barrier operator 120 due to simultaneously exchanged communications that may cross paths in the communication network(s).

In some examples, the remote user device 108b may provide a delivery driver an input on the display to close the barrier after the delivery has been completed. In such an instance, a barrier close request may be transmitted to the barrier operation 120 through the partner cloud processing platform 175 and the operator cloud processing platform 170. Upon receipt of the barrier close request, the barrier operator 120 may terminate the timer-to-close timer. In some examples, the delivery driver may not initiate a barrier close request or a network outage may prevent transmission of a barrier close request to the barrier operator 120. The timer-to-close function may ensure the barrier operator 120 closes the barrier upon expiration of the timer of the timer-to-close function in the event the barrier remains open at the expiration of the timer.

In some examples, the barrier operator 120 may perform an IMN in response to receipt of the barrier open request 106. In some examples, the barrier operator 120 may perform an IMN upon or near expiration of the timer of the timer-to-close function and prior to initiating closing movement of the barrier.

It will be understood that the first communication is received by the barrier control module 121 (FIG. 2). It is then processed by the barrier control module 121, which may include obtaining status information from the barrier controller 122 or alert module 124. The barrier control module 121, in turn, then sends the acknowledgement communication 105 to the operator cloud processing platform 170. Only after receipt of the acknowledgement communication 105 will the operator cloud processing platform 170 transmit a barrier open request 106 to the barrier operator 120. This order of operations ensures the barrier operator 120 has the timer value for the timer-to-close function and has a current status indicating barrier movement can be attempted before a barrier open request 106 is transmitted to the barrier operator 120.

In some embodiments, execution of barrier closing movement upon the expiration of the timer-to-close function may result in the barrier operator 120 transmitting a confirmation signal to the operator cloud processing platform 170 confirming the barrier has been closed. This information may then be presented to a user via the remote user device 180a and/or 180b. In some examples, the barrier operator 120 may be configured to routinely transmit door position information (e.g., periodically at defined intervals or upon each door movement regardless of the origin of the movement request) such that barrier operator 120 will transmit the updated door position information in due course.

If the barrier open request 106 or the automatic closure at expiration of the timer-to-close timer is not able to be fully implemented (e.g., an IMN could not performed, an obstruction was detected, or the movement was interrupted), a status notification may be transmitted to the operator cloud processing platform 170 and subsequently to remote user device 180a and/or 180b.

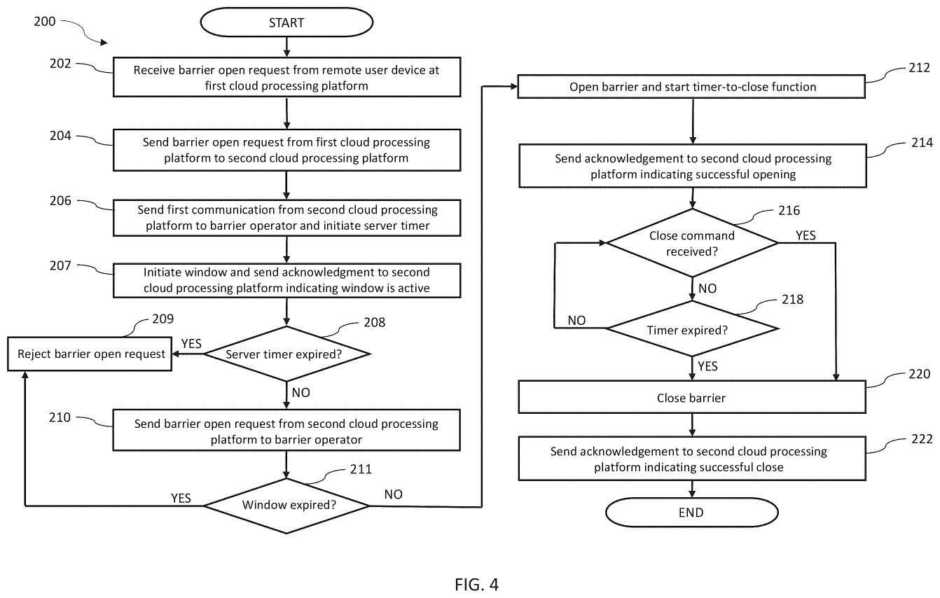

FIG. 4 illustrates a flow chart of a method 200 for implementing barrier movement in response to a barrier open request from a remote user device. At process 202, a cloud processing platform, such as partner cloud processing platform 175, receives a barrier open request initiated by a user at a remote user device, such as barrier open request 102 from remote user device 180b. The barrier open request indicates that the user has instructed movement of the barrier from a closed position to an open position. At process 204, in response to receiving the barrier open request, the cloud processing platform transmits a barrier open request, such as barrier open request 103, to a second cloud processing platform such as operator cloud processing platform 170. In some examples, process 204 may be omitted such as when a single cloud processing platform is used as cloud processing platform 170 and cloud processing platform 175.

In response to receipt of the barrier open request from the partner cloud processing platform, or in response to receipt of the barrier open request from the remote user device in the event a single cloud processing platform is used, at process 206 the second cloud processing platform transmits a first communication to a barrier operator identified based upon the received barrier open request. The first communication may include a timer value to be utilized by the barrier operator if and when it receives a subsequent barrier open request at a later time. Upon transmitting the first communication or shortly before or after transmitting the first communication, the second cloud processing platform may initiate a server timer during which the second cloud processing platform will await a window acknowledgement from the barrier operator.

Upon receipt of the first communication, at process 207 the barrier operator may perform validations and if a barrier movement is able to be performed will initiate a window of time during which it will be configured to initiate a timer-to-close function if and when a barrier open request is received. If the barrier operator determines a barrier movement cannot be performed, the barrier operator may send a status communication to the second cloud processing platform causing the platform to reject the barrier open request. If the barrier operator determines a movement may be performed, the barrier operator transmits a window acknowledgement communication to the second cloud processing platform indicating that the window of time has been initiated. Failure to receive a window acknowledgement from the barrier operator prior to expiration of the server timer may cause the second cloud processing platform to reject the barrier open request received from the first cloud processing platform. In some examples, the method may instead return to process 206 and attempt to resend the first communication. If the server timer has not expired prior to receipt of the window acknowledgement, at process 210, in response to receiving the window acknowledgement, the cloud processing platform transmits a barrier open request to barrier operator.

At process 211, one or more validations may be performed by the barrier operator to determine if it is still able to perform a barrier movement. This includes determining whether the window of time has expired. If the window has expired, the barrier operator may reject the barrier open request and transmit a status communication to the second cloud processing platform. The second cloud processing platform may then return to process 206.

At process 212, if the barrier operator has determined the barrier open request can be performed, the barrier operator will execute the barrier open request to move the barrier. This may include the barrier control module instructing the barrier controller which, in turn, activates the motor to move the barrier. At the same time as opening the barrier, or shortly therebefore or thereafter, the barrier operator initiates the timer-to-close function which may use a timer value from the first communication if one is included. In some examples, a default or fixed timer value may be used. Optionally, at process 214 which may occur before, after, or simultaneously with process 212, the barrier operator transmits an open acknowledgement to the second cloud processing platform indicating that the barrier has been opened or will soon be opened and the timer-to-close function has been initiated or will soon be initiated.

At optional process 216, the barrier operator determines whether a close command has been received from any source. If so, the barrier operator may close the barrier and terminate the timer-to-close function without further action taken with respect thereto, although a close acknowledgement or position status update may be sent to the second cloud processing platform indicating the barrier is closed. If a close command has not been received, at process 218 the barrier operator may determine if the timer-to-close function timer has expired. If not, the process may loop back to process 216 or may await expiration of the timer. If the timer has expired at process 218, the barrier operator may close the barrier at process 220 and subsequently or simultaneously transmit a close acknowledgement to the second cloud processing platform at process 222.

Although the method 200 may be utilized for all remote server based open commands, it should be appreciated that in some examples the method 200 may be performed only for barrier open requests received from a partner cloud processing platform and when the barrier is closed. In this regard, barrier movement requests instructing the barrier operator to transition the barrier from the open position to closed position or barrier open requests received from a user device 180a that are not routed through a partner cloud processing platform may omit some or all of processes 202-222 in some examples.

While the above description pertains to an example in which a partner cloud processing platform is configured to send a barrier open request initiated by a remote user device such as a delivery computer, it should be appreciated that in some examples, a partner cloud processing platform may be omitted without departing from the principles of the present disclosure. For example, in some embodiments of the system 100 of FIGS. 1-3, the remote user device 180b and partner cloud processing platform 175 may be omitted. A barrier open request may be initiated by user input on remote user device 180a and the barrier open request, which may include a timer value, may be routed through the operator cloud processing platform 170 as previously described.

In some examples, a user may manually enter or select from a menu a desired timer value for a timer-to-close function. In some examples, a user may configure the barrier operator system 100 to associate particular timer values with different remote controls, remote user devices, keypad pin numbers, guest access accounts, or other differentiators. In this regard, as one example, a user may configure the barrier operator system 100 such that a first barrier open request from a first remote user device of a first user will utilize a first timer value and a second barrier open request from a second remote user device of a second user will utilize a second timer value. The timer first and second timer values may be transmitted from the respective remote user device with a barrier open request or may be stored in a database on the operator cloud processing platform and associated with a particular barrier open request based on information contained in the barrier open request (e.g., user account or remote user device initiating the request).

In some examples, a particular delivery may be associated with a particular timer value at the remote user device 180a. For example, upon receiving a shipping confirmation email, a user may manually enter the tracking number or other order identifier into a user interface of the remote user device and associate a timer value with the tracking number. This information may be stored at the operator cloud processing platform. At the time of delivery, the delivery driver may provide the tracking number (via a bar code scan, manual entry into a keypad, etc.) which may be routed to the operator cloud processing platform 170 and the barrier operator system 100 will initiate the timer-to-close function using the timer value associated with the delivery.

In the description, specific details have been set forth describing some examples. Numerous specific details are set forth in order to provide a thorough understanding of the examples. It will be apparent, however, to one skilled in the art that some examples may be practiced without some or all of these specific details. The specific examples disclosed herein are meant to be illustrative but not limiting. One skilled in the art may realize other elements that, although not specifically described here, are within the scope and the spirit of this disclosure.

Elements described in detail with reference to one example, example, implementation, or application optionally may be included, whenever practical, in other examples, implementations, or applications in which they are not specifically shown or described. For example, if an element is described in detail with reference to one example and is not described with reference to a second example, the element may nevertheless be claimed as included in the second example. Thus, to avoid unnecessary repetition in the foregoing description, one or more elements shown and described in association with one example, implementation, or application may be incorporated into other examples, implementations, or application unless specifically described otherwise, unless the one or more elements would make an example or implementation non-functional, or unless two or more of the elements provide conflicting functions. Similarly, it should be understood that any particular element, including a system component or a method process, is optional and is not considered to be an essential feature of the present disclosure unless expressly stated otherwise.

Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure. In addition, dimensions and temporal relationships provided herein are for providing specific examples and it is contemplated that different sizes, dimensions, relationships and/or ratios may be utilized to implement the concepts of the present disclosure. To avoid needless descriptive repetition, one or more components or actions described in accordance with one illustrative example can be used or omitted as applicable from other illustrative examples. For the sake of brevity, the numerous iterations of these combinations will not be described separately. For simplicity, in some instances the same reference numbers are used throughout the drawings to refer to the same or like parts.

The methods described herein are illustrated as a set of operations or processes. Not all the illustrated processes may be performed in all examples of the methods. Additionally, one or more processes that are not expressly illustrated or described may be included before, after, in between, or as part of the example processes. In some examples, one or more of the processes may be performed by a controller and/or may be implemented, at least in part, in the form of executable code or instructions stored on non-transitory, tangible, computer or machine-readable media that when run by one or more processors may cause the one or more processors to perform one, some, or all the processes described in relation to the methods herein. Elements illustrated in block diagrams herein may be implemented with hardware, software, firmware, or any combination thereof. One block element being illustrated separate from another block element does not necessarily require that the functions performed by each separate element requires distinct hardware or software but rather they are illustrated separately for the sake of description.

One or more elements in examples of this disclosure may be implemented in software to execute on one or more processors of a computer system such as a controller. When implemented in software, the elements of the examples of the present disclosure are essentially the code segments to perform the necessary tasks. The program or code segments can be stored in a processor readable storage medium or device that may have been downloaded by way of a computer data signal embodied in a carrier wave over a transmission medium or a communication link. The processor readable storage device may include any medium that can store information including an optical medium, semiconductor medium, and magnetic medium. Processor readable storage device examples include an electronic circuit; a semiconductor device, a semiconductor memory device, a read only memory (ROM), a flash memory, an erasable programmable read only memory (EPROM); a floppy diskette, a CD-ROM, an optical disk, a hard disk, or other storage device. The code segments may be downloaded via computer networks such as the Internet, Intranet, etc. Any of a wide variety of centralized or distributed data processing architectures may be employed. Programmed instructions may be implemented as a number of separate programs or subroutines, or they may be integrated into a number of other aspects of the systems described herein. In one example, systems herein support wireless communication protocols such as RF, Bluetooth, IrDA, HomeRF, IEEE 802.11, DECT, and Wireless Telemetry.

Note that the presented devices and methods may not inherently be related to any particular computer or other apparatus. Various general-purpose systems may be used with programs in accordance with the teachings herein, or it may prove convenient to construct a more specialized apparatus to perform the operations described. The required structure for a variety of these systems will appear as elements in the claims. In addition, the examples of the present disclosure are not described with reference to any particular programming language. It will be appreciated that a variety of programming languages may be used to implement the teachings of the present disclosure.

In some instances, well-known methods, procedures, components, and circuits have not been described in detail so as not to unnecessarily obscure aspects of the examples.

While certain exemplary examples of the present disclosure have been described and shown in the accompanying drawings, it is to be understood that such examples are merely illustrative of and not restrictive on the broad disclosure herein, and that the examples of the present disclosure should not be limited to the specific constructions and arrangements shown and described, since various other modifications may occur to those ordinarily skilled in the art.

What is claimed is:

1. A barrier operator for manipulating a barrier, the barrier operator comprising:
a motor operable to move the barrier between a closed position and an open position;
a barrier control module configured to communicate with a remote server; and
one or more processors configured to:
receive a first communication from the remote server;
initiate a window of time in response to receipt of the first communication;
receive a barrier open request; and
in response to receipt of the barrier open request during the window of time:
initiate a timer; and
in response to expiration of the timer, close the barrier.

2. The barrier operator of claim 1, wherein the barrier open request is received from the remote server and the one or more processors are further configured to:
in response to receipt of the barrier open request after the window of time has elapsed, reject the barrier open request.

3. The barrier operator of claim 1, wherein the first communication comprises a timer value and the one or more processors are configured to initiate the timer using the timer value.

4. The barrier operator of claim 1, wherein the barrier open request is received from a local transmitter.

5. The barrier operator of claim 4, wherein the local transmitter is a wireless transmitter.

6. The barrier operator of claim 1, wherein the barrier control module and the one or more processors are disposed in a wall-mounted or ceiling-mounted console remote from a housing in which the motor is disposed, the console being configured to wirelessly transmit the barrier open request to a barrier controller of the barrier operator, the barrier controller configured to control operation of the motor.

7. The barrier operator of claim 1, wherein the one or more processors are further configured to:
transmit a window acknowledgement to the remote server in response to determining the barrier operator is able to initiate the window of time.

8. The barrier operator of claim 1, wherein the one or more processors are further configured to:
transmit an open command acknowledgement to the remote server in response to receipt of the barrier open request.

9. The barrier operator of claim 1, wherein the one or more processors are further configured to:
transmit an open command acknowledgement to the remote server in response to determining the barrier operator is able to execute the barrier open request.

10. The barrier operator of claim 1, wherein the one or more processors are further configured to:
transmit a close acknowledgement to the remote server in conjunction with the closing of the barrier.

11. A server configured to communicate with a barrier operator, wherein the server is configured to:
transmit a first communication to the barrier operator;
receive a window acknowledgement from the barrier operator, the window acknowledgement indicating the barrier operator has initiated a window of time; and
in response to receipt of the window acknowledgement, transmit a barrier open request to the barrier operator.

12. The server of claim 11, wherein the server is configured to transmit the first communication to the barrier operator in response to receipt of the barrier open request from a partner platform.

13. The server of claim 12, wherein the server is further configured to:
initiate a timer in response to transmitting the first communication; and
in response to expiration of the timer, reject the barrier open request received from the partner platform.

14. The server of claim 13, wherein the server is further configured to:
terminate the timer in response to receipt of a window acknowledgement from the barrier operator indicating the barrier operator is able to initiate the window of time.

15. The server of claim 12, wherein the server is further configured to:
receive a close acknowledgement from the barrier operator indicating the barrier operator has closed a barrier; and
transmit a close confirmation to the partner platform.

16. A barrier operator system, comprising:
a remote server; and
a barrier operator configured to move a barrier,
wherein the remote server is configured to:
transmit a first communication to the barrier operator;
receive a window acknowledgement from the barrier operator, the window acknowledgement indicating the barrier operator has initiated a window of time; and
in response to receipt of the window acknowledgement, transmit a barrier open request to the barrier operator; and
wherein the barrier operator is configured to:
receive the first communication from the remote server;
initiate the window of time in response to receipt of the first communication and transmit the window acknowledgement;
receive the barrier open request; and
in response to receipt of the barrier open request during the window of time:
initiate a timer; and
in response to expiration of the timer, close the barrier.

17. The barrier operator system of claim 16, wherein the barrier operator is further configured to:
in response to receipt of the barrier open request after the window of time has elapsed, reject the barrier open request.

18. The barrier operator system of claim 16, wherein the first communication comprises a timer value and the barrier operator is configured to initiate the timer using the timer value.

19. The barrier operator system of claim 16, wherein the barrier open request is received from a local transmitter.

20. The barrier operator system of claim 16, wherein the barrier operator comprises a remote module configured to wirelessly transmit the barrier open request to a barrier controller of the barrier operator, the barrier controller configured to control operation of a motor.
